(19) United States
(12) Patent Application Publication
(10) Pub. No.: US 2026/0157934 A1
(43) Pub. Date: Jun. 11, 2026

(54) Pill Storage and Dispensing System

(71) Applicants: Kezheng Li, McLean, VA (US); Daniel Bugianesi, Bridgewater, NJ (US)

(72) Inventors: Kezheng Li, McLean, VA (US); Daniel Bugianesi, Bridgewater, NJ (US)

(21) Appl. No.: 19/415,623

(22) Filed: Dec. 10, 2025

Related U.S. Application Data
(60) Provisional application No. 63/730,091, filed on Dec. 10, 2024.

(51) Int. Cl. A61J 7/00; B65D 83/04

(52) U.S. Cl. CPC A61J 7/0076; B65D 83/0409

(57) ABSTRACT

A pill dispenser has a first assembly and a second assembly. The first assembly includes a storage container for holding a plurality of pills and a first funnel at the bottom of the storage container for directing the pills to a first staging area configured to fit a pill. The second assembly has a diaphragm with a first opening configured to fit the pill, and an agitator positioned within the storage container. The first assembly and second assembly may be rotated opposite each other along a central axis such that the agitator agitates the plurality of pills, causing the pill to be diverted into the first funnel, falling into and occupying the first staging area. With further rotation of the first and second assembly, the first opening aligns with the first staging area, allowing the first pill to be dispensed from the first staging area through the diaphragm.

### CROSS REFERENCE

This application claims the benefit of U.S. Provisional Application No. 63/714,091, filed 16 Oct. 2048, which application is incorporated herein by reference.

### BACKGROUND

In both clinical and at-home healthcare settings, maintaining the sterility and accuracy of medication dispensing is critical to ensuring patient safety and treatment efficacy. Traditional pill dispensing methods often involve manual handling, which increases the risk of contamination, dosage errors, and improper medication management. To address these concerns, sterile pill dispensers are needed that are hygienic and reliable. A sterile pill dispenser is a device designed to store, organize, and dispense medication while preserving its sterility. These dispensers often incorporate features such as sealed compartments and automated dispensing mechanisms. However, there is a lack of available pill dispensers that provide a manual pill dispensing method that is still sterile and practical.

### SUMMARY

What is presented is a pill dispenser comprising a first assembly that comprises a storage container and a first funnel. The storage container holds a plurality of pills and the first funnel is attached to a bottom portion of the storage container for directing the plurality of pills to a first staging area. The pill dispenser further comprises a second assembly, in which the second assembly comprises a diaphragm that has a first opening configured to fit one of the plurality of pills and an agitator positioned within the storage container of the first assembly. The first assembly and the second assembly may be rotated opposite to each other along a central axis such that the agitator agitates the plurality of pills, causing a first pill to be diverted into the first funnel and falls into and occupies the first staging area and the first opening aligns with the first staging area, allowing the first pill to be dispensed from the first staging area through the diaphragm.

The first assembly further comprises a second staging configured to fit one of the plurality of pills and a second funnel attached to a bottom portion of the storage container for directing the plurality of pills to the second staging area. The diaphragm further comprises a second opening configured to fit one of the plurality of pills. The rotation of the first assembly and second assembly opposite to each other along the central axis causes the agitator to agitate the plurality of pills. This causes the first pill to be diverted into the first staging area and a second pill to be diverted into the second staging area. The first opening will align with the first staging area and the second opening will align with the second staging area, allowing the first pill and the second pill to be dispensed from the first assembly through the diaphragm. A blocking mechanism may be manipulated to block one of the first opening and the second opening of the diaphragm, such that only the first pill or the second pill is dispensed from the first assembly through the diaphragm. In one variation, a blocking mechanism may be manipulated to block one of the first funnel or second funnel, such that only the first pill or the second pill is dispensed from the first assembly through the second assembly.

A collection cap may be positioned below the diaphragm for collecting the pills after they have been dispensed through the diaphragm. The collection cap and diaphragm may comprise a series of magnets for securing the collection cap to the diaphragm. A top pusher cap may be positioned above the storage container with a push rod connected to the top pusher cap. The push rod is positioned through a center of the pill dispenser. The top pusher cap may be displaced vertically, while simultaneously displacing the push rod vertically, engaging the collection cap and disengaging the series of magnets such that the pill can be retrieved from the collection cap. The top pusher cap may further comprise a detent including a ball bearing and spring, with the detent being configured to lock the push rod in place when the top pusher cap is displaced. A cover may be positioned between the top pusher cap and the storage container to prevent the pills from interfering with the top pusher cap.

The pill dispenser may further include a first sleeve in the first assembly that encompasses the pushrod through the storage container and the funnel. The first sleeve includes a cutout designed to receive a complementary cutout. The second sleeve encompasses the push rod through the diaphragm and includes a complementary cutout designed to receive a cutout from the first sleeve. In this instance, the process of displacing the top pusher cap results in the first sleeve being displaced along with the push rod, causing the complementary cutout to receive the cutout.

The staging area of the pill dispenser may include a spring-loaded ball bearing. The funnel may include a series of recesses such that when the first assembly is rotated relative to the second assembly, the spring-loaded ball bearing engages the series of recesses when at least two of the holes align with at least two of the openings. The diaphragm of the pill dispenser may include a grip for adjusting the position of the diaphragm. The staging area may also include a loading area configured to fit the pill and is attached to the funnel such that the pill is in position to move through at least one of the two openings.

The pill dispenser may further comprise of a selector mechanism attached to the blocking mechanism and extends to an external side portion of the pill dispenser, allowing manipulation of the blocking mechanism. The pill dispenser may also comprise a locking mechanism, including a lobe located on a distal end of the selector mechanism, which is configured to engage with one of two recesses located on opposite sides of an interior side portion of the pill dispenser. The selector mechanism may be indexed in 180 degree increments and is locked into place to prevent involuntary motion.

In one embodiment, the pill dispenser comprises a first assembly that further comprises a storage container for holding a plurality of pills and a first funnel attached to a bottom portion of the storage container for directing the plurality of pills to a first staging area and a second staging area, each configured to fit one of the plurality of pills. The pill dispenser also comprises a second assembly having a diaphragm with a first opening configured to fit one of the plurality of pills and an agitator positioned within the storage container of the first assembly. The first assembly and second assembly may be rotated opposite each other along a central axis such that the agitator agitates the plurality of pills, causing a first pill to be diverted into and occupy the first staging area, and causes a second pill to be diverted into and occupy the second staging area. Upon further rotation of the first assembly and second assembly, the first opening aligns with the first staging area, thereby allowing said first pill to be dispensed through the first opening into the collection cap. In the same rotation, if the blocking mechanism is in the two pill position, the second opening aligns with the second staging area, thereby allowing the first pill to be dispensed through the second opening into the collection cap. The diaphragm also comprises a first series of magnets, while the pill dispenser further comprises a collection cap for collecting the pills after being dispensed. The collection cap has a second series of magnets that attach to the first series of magnets of the diaphragm. The pill dispenser further comprises a top pusher cap positioned above the storage container and a push rod connected to the top pusher cap and positioned through a center of the pill dispenser. When the top pusher cap is displaced, the push rod is simultaneously displaced vertically, engaging the collection cap and disengaging the first series of magnets from the second series of magnets such that the pill can be retrieved from the collection cap.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a perspective view of the pill dispenser;

FIG. 2 is a cross-sectional view of the pill dispenser of FIG. 1 as indicated in FIG. 1 [2-2];

FIG. 3 is a cross-sectional view of the pill dispenser of FIG. 1 as indicated in FIG. 1 [3-3];

FIG. 4 is an exploded view of the pill dispenser of FIG. 1;

FIG. 5 is a cross-sectional view of the push rod assembly as seen in FIG. 2;

FIG. 6 is a cross-sectional view of the first assembly of the pill dispenser as seen in FIG. 2;

FIG. 7 is a perspective view of the second assembly of the pill dispenser;

FIG. 8. is a cross-sectional view of the ball detent mechanism between second and third layers as indicated in FIG. 1 [8-8];

FIG. 9 is a perspective view of the selector mechanism in the blocked position;

FIG. 10 is a perspective view of the selector mechanism in the unblocked position and showing the bottom container;

FIG. 11 is a cutout view of the locking mechanism;

FIG. 12 is a cross-sectional view of the pill dispenser in the 3-3-direction with a first pill positioned in the first staging area, a second pill positioned in the second staging area, and with the blocking the second opening;

FIG. 13 is a cross-sectional view of the pill dispenser in the 3-3-direction with a first pill being dispensed through the first opening and a second pill in the second staging area blocked from exiting the second staging area, by the diaphragm;

FIG. 14 is a cross-sectional view of the pill dispenser in the 3-3-direction with a first pill in the bottom container and a second pill in the second staging area, blocked from exiting the second staging area, by the diaphragm;

FIG. 15 is a cross-sectional view of the pill dispenser in the 2-2-direction with a first pill in the bottom container, a third pill in the third staging area, and a fourth pill in the fourth staging area blocked from exiting the fourth staging area;

FIG. 16 is a cross-sectional view of the pill dispenser in the 3-3-direction with a fourth pill in the first staging area, a second pill in the second staging area blocked from exiting the second staging area, a third pill being dispensed through the second opening, and a first pill located in the bottom container; and

FIG. 17 is a cross-sectional view of the pill dispenser in the 3-3-direction without a diaphragm where a first pill is being dispensed through the first opening and a second pill is being dispensed through a second opening.

### DETAILED DESCRIPTION

Methods of dispensing pills for both clinical and at-home healthcare settings require sterile conditions and accurate dispensing of medications, which are critical to ensure patient safety and treatment efficacy. Currently pill dispensing methods involve manually handling pills which requires a user to touch the pills thereby increasing the risk of contamination. Furthermore, the risk of user error increases, which typically leads to increased risk of dosage errors and improper medication management. What is presented is a solution that reduces these risks.

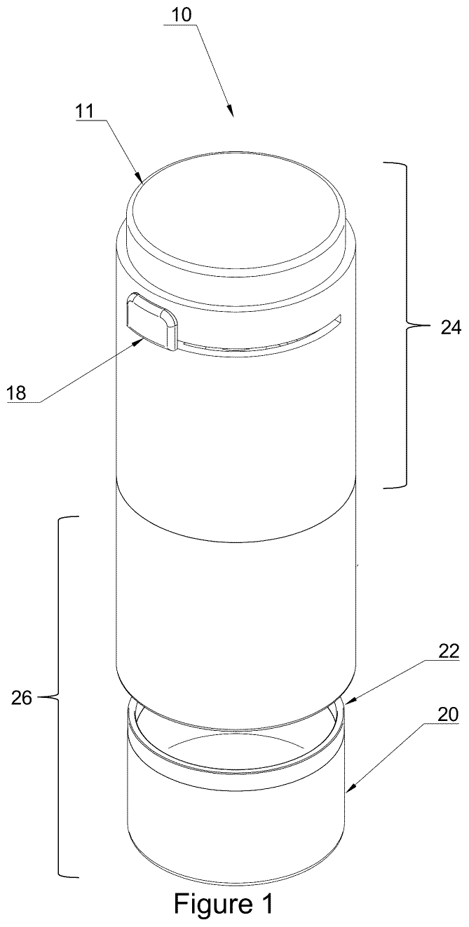

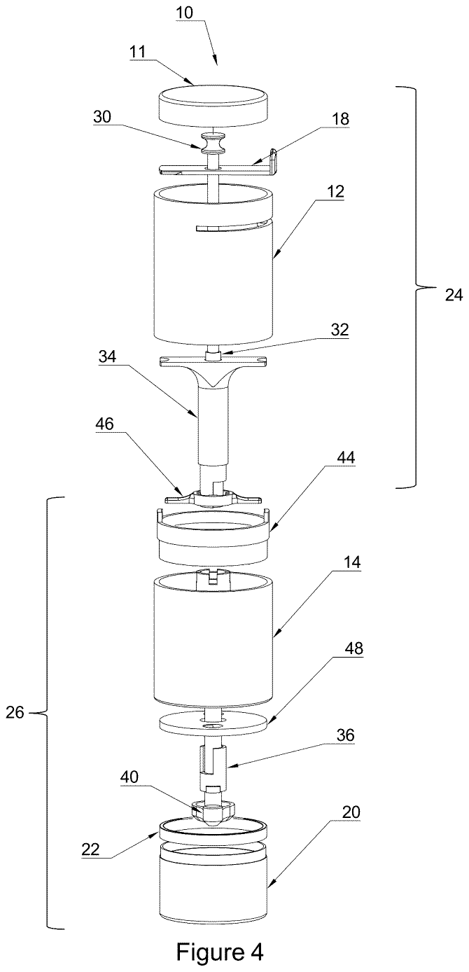

FIG. 1 through FIG. 4 depict a pill dispenser 10 for dispensing pills (not shown). The pill dispenser 10 contains a first assembly 24 and second assembly 26 in which the first assembly 24 and the second assembly 26 are rotated opposite each other, about a central axis, such that the pills are dispensed. A top pusher cap 11 on a top portion of the pill dispenser 10, a storage container 12 for holding a plurality of pills, a first staging area 16, and a selector mechanism 18 that allows a user to select between a one pill or two pill position, resulting in one or two pills being dispensed, respectively. The pill dispenser 10 contains a bottom container 20 that receives one or two pills being dispensed. A user may detach the bottom container 20 from the pill dispenser 10 such that the pills housed in the bottom container 20 can be readily consumed by a user. In FIG. 1, the bottom container 20 is attached to the second assembly 26 of the pill dispenser 10 using a second series of magnets 22, but may include, and is not limited to, singular magnets, a friction fit, or any other fit that could be reasonably inferred by a person of ordinary skill in the art.

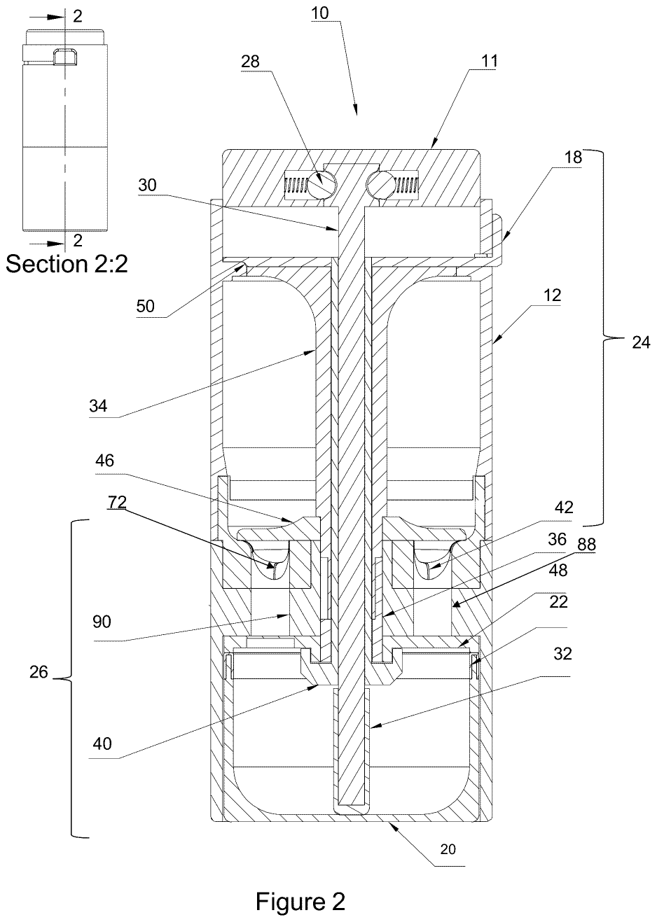

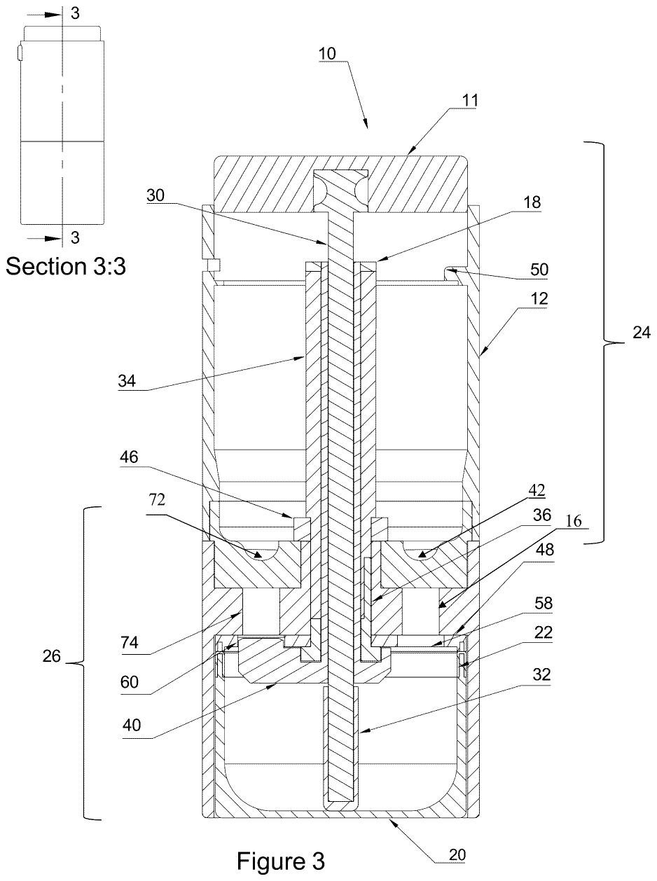

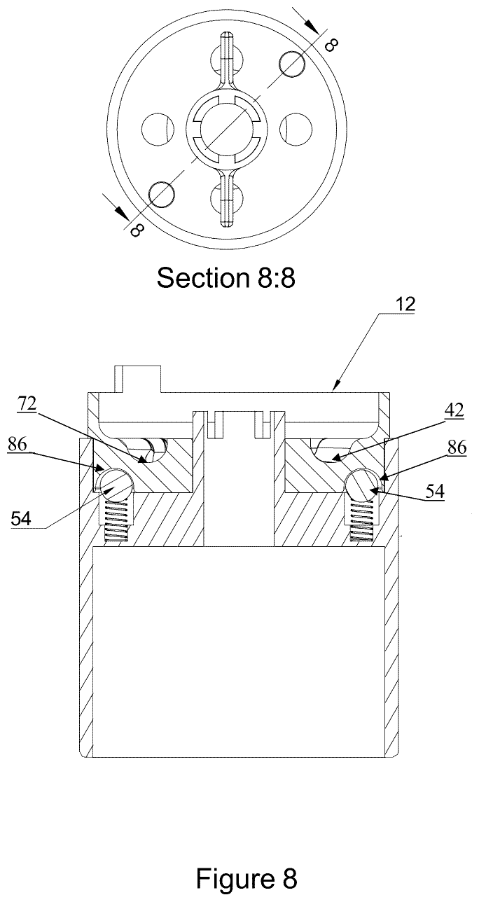

Cross-sectional lines on the pill dispenser 10 are provided for clarification. Cross-sectional line 2:2 and section 2:2 correspond to FIG. 2. Cross-sectional line 3:3 and section 3:3 correspond to FIG. 3. Cross-sectional line 8:8 and section 8:8 correspond to FIG. 8.

A user may depress the top pusher cap 11 on a top portion of the pill dispenser 10 such that a ball detent 28 engages with the top pusher cap 11 to lock the top pusher cap 11 into place and prevent involuntary removal of the top pusher cap. A push rod 30 transfers motion from the top pusher cap 11 to a push rod cap 32. The push rod 30 is housed in a first sleeve 34 and second sleeve 36, comprising a center pin (not shown). The motion from the top pusher cap 11 and the push rod 30 is transferred to the push rod cap 32 so that the bottom container 20 with the second series of magnets 22 that is connected to a first series of magnets 38 disengages from a blocking mechanism 40. The storage container 12 holds a plurality of pills and connects to a first funnel 42 and second funnel 72. The first funnel 42 and second funnel 72 are part of the first assembly 24, while the agitator 46 is part of the second assembly 26. The first assembly 24 and second assembly 26 may be rotated opposite to each other along a central axis, manipulating the agitator 46 to agitate a plurality of pills. When the agitator 46 is manipulated, a pill is diverted into the first funnel 42 or second funnel 72 and falls into and occupies a first staging area 16 or second staging area 74, respectively. After a pill falls into and occupies a first staging area 16 or second staging area 74, upon further rotation of the first assembly 24 and second assembly 26, the first staging area 16 or second staging area 74 aligns with a first opening 58 or second opening 60 of a diaphragm 48, respectively. When this alignment occurs, this allows for a pill to be dispensed from the first staging area 16 or second staging area 74 through the diaphragm 48. The diaphragm 48 of the pill dispenser 10 houses the blocking mechanism 40, in which the blocking mechanism 40 is used to block pills from being dispensed when a user toggles the selector mechanism 18 to a one or two pill position. The pill dispenser 10 further contains a locking mechanism 50 that locks the selector mechanism 18 to a one or two pill position.

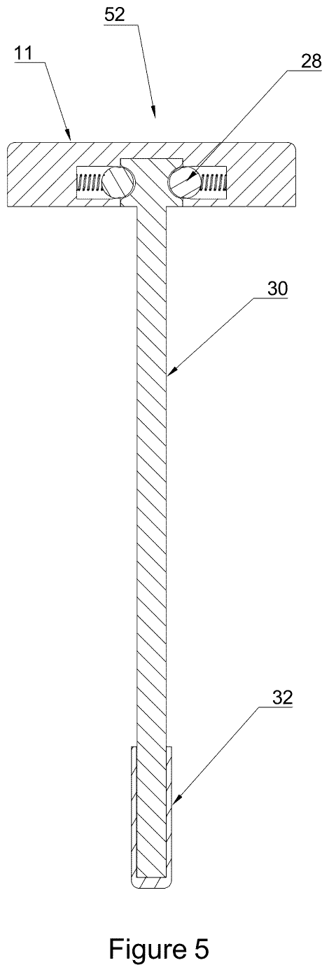

FIG. 5 depicts a push rod assembly 52. The push rod assembly 52 comprises the top pusher cap 11, the ball detent 28, the push rod 30, and the push rod cap 32. A user depresses the top pusher cap 11 such that the push rod 30 is displaced from the downward motion, resulting in the push rod cap 32 interacting with the bottom container 20. The displacement of the push rod 30 also locks the proximal end of the push rod 30 into place using the ball detent 28. A user may depress the spring-loaded assembly 56 a second time, such that the push rod 30 is displaced from the downward motion, releasing the proximal end from the ball detent 28 and returning the push rod 30 to its original position. In another embodiment not shown, the push rod assembly 52 does not include the ball detent 28. When a user depresses the top pusher cap 10, the push rod 30 is displaced from the downward motion, but the proximal end of the push rod 30 is not locked into place. The push rod cap 32 interacts with the bottom container 20, but after the single depression of the top pusher cap, the push rod 30 is returned to its original position.

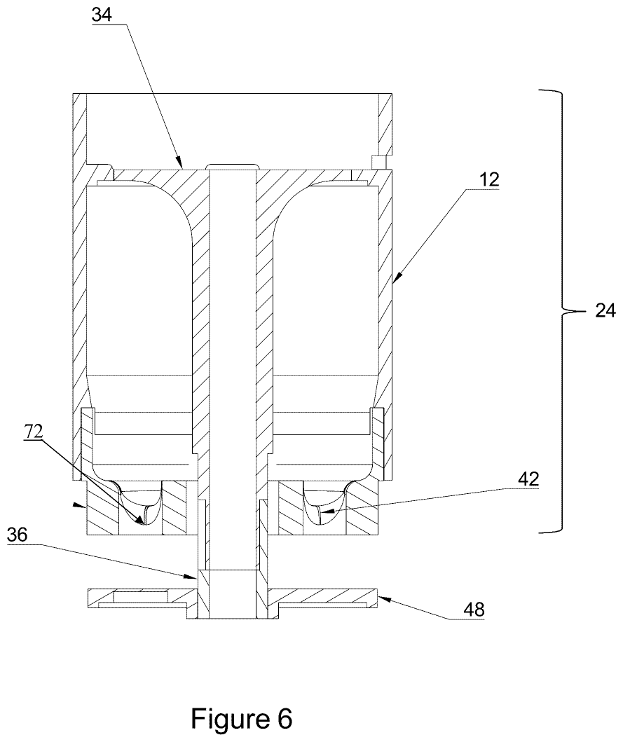

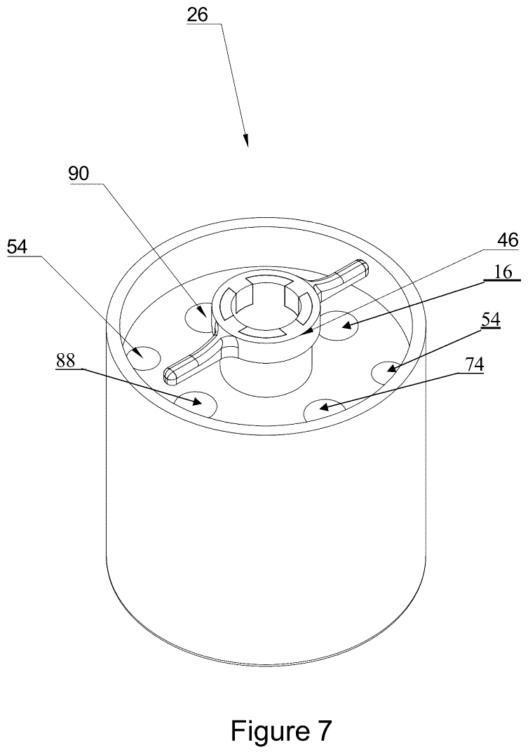

FIG. 6 depicts a cross section of the first assembly 24 of the pill dispenser 10, which comprises the first sleeve 34, storage container 12, the first funnel 42, and second funnel 72. FIG. 6 also depicts a portion of the second assembly 26, specifically the second sleeve 36 and the diaphragm 48. FIG. 7 depicts the second assembly 26 of the pill dispenser 10, the second assembly ball detent 54, the agitator 46, the first staging area 16, second staging area 74, third staging area 88, and fourth staging area 90. FIG. 8 depicts a cross-section of the second assembly 26, showing the storage container 12, first funnel 42, second funnel 72, second assembly ball detent 54, and two second assembly recesses 86. The first assembly 24 and second assembly 26 may be rotated opposite to each other along a central axis, manipulating the agitator 46 to agitate a plurality of pills. When the agitator 46 is manipulated, a pill is diverted into the first funnel 42 and second funnel 72 and falls into and occupies the first staging area 16, second staging area 74, third staging area 88, or fourth staging area 90. The pill dispenser 10 comprises a first funnel 42 and a second funnel 72, so no more than two staging areas are occupied by a pill at any given time. After a pill falls into and occupies no more than two of the staging areas, upon further rotation of the first assembly 24 and second assembly 26, no more than two of the occupied staging areas align with a first opening 58 or second opening 60 of a diaphragm 48, allowing for the pills occupying staging areas to be dispensed from either the first opening 58 or second opening 60, or both depending on the position of the blocking mechanism 40, through the diaphragm 48. In this same rotation, a pill is diverted into the first funnel 42 and second funnel 72 and falls into and occupies the two staging areas that are not currently occupied by pills. Each rotation of the first assembly 24 and second assembly 26 opposite to each other on a central axis is indexed in 90-degree increments with the second assembly ball detent 54 and second assembly recesses 86, as shown in FIG. 8. The presence of four staging areas allows for pills that were occupying two staging areas to be dispensed through the diaphragm 48, depending on the position of the blocking mechanism 40, in one rotation, while also allowing new pills to fall into and occupy the staging areas that were previously not occupied, in the same rotation.

Shown best in FIG. 7, the four staging areas in the embodiment shown allows for two pills to enter in two staging areas in a single rotation of the first assembly 24 and second assembly 26. In that same rotation, if there were two pills in the other two staging areas, those two pills would be dispensed through the first opening 58 and second opening 60 of the diaphragm 40. Depending on the blocking mechanism 48 and whether it was in the one pill or two pill position, one or two pills would have been dispensed from the staging areas in the same rotation. If there were, for example, only two staging areas, the dispensing of pills and the loading of pills into the two staging areas would have to be performed in separate rotations. This would result in two rotations of the pill dispenser being necessary to both load and dispense pills.

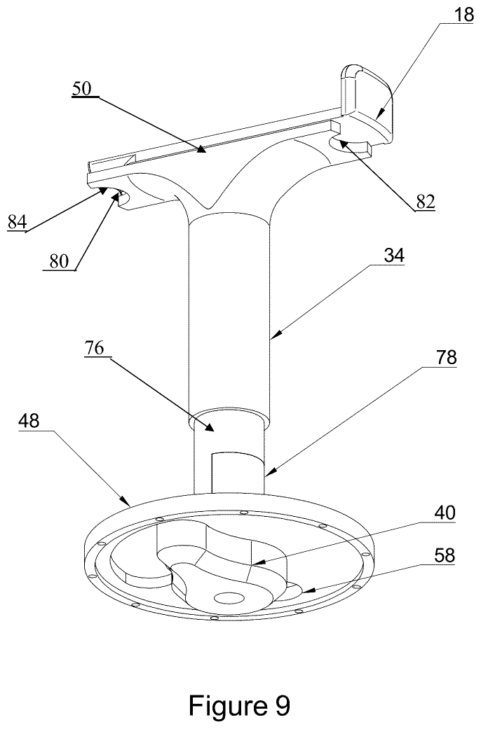

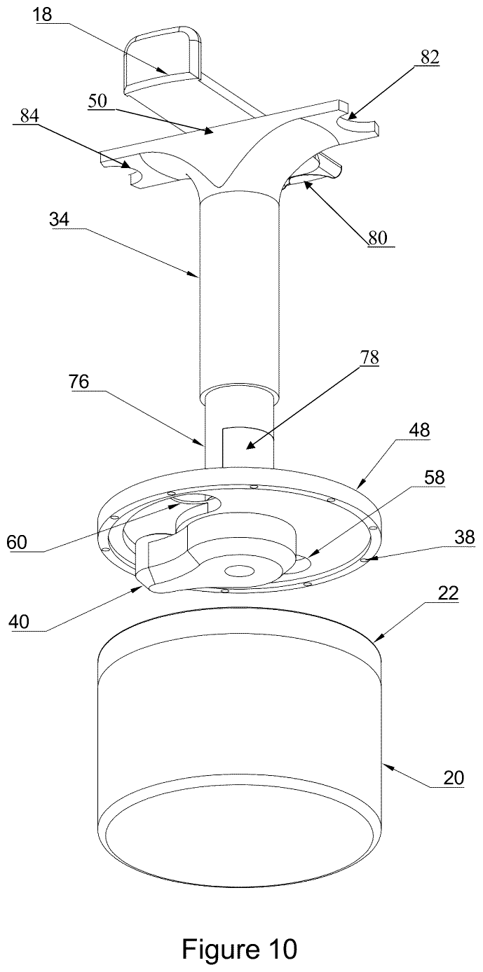

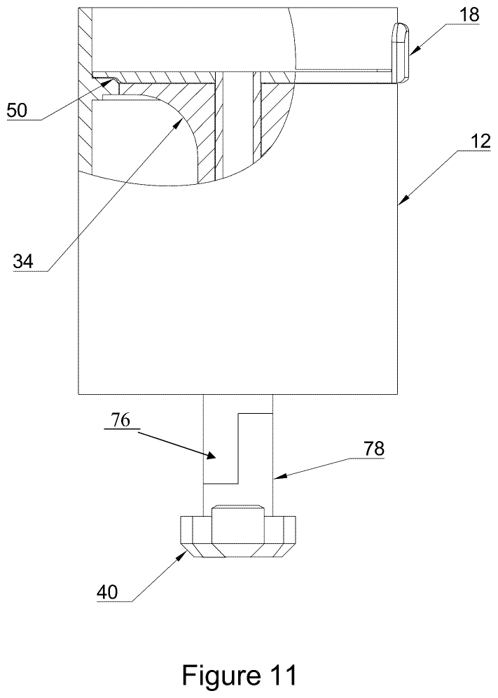

As best understood by comparing FIGS. 9, 10, and 11, FIG. 9. depicts the selector mechanism 18 in which the blocking mechanism 40 is in a blocked, or one pill position. In the one pill position, the first opening 58 is not blocked by the blocking mechanism 40, and the second opening 60 is blocked by the blocking mechanism 40. FIG. 10 depicts the selector mechanism 18 in which the blocking mechanism 40 is in an open, or two pill position. In the two pill position, the first opening 58 and second opening 60 are not blocked by the blocking mechanism 40. The selector mechanism 18 runs through the first sleeve 34 and second sleeve 36, connecting to the blocking mechanism 40. The selector mechanism 18 has a tab located on an external side portion of the pill dispenser 10 such that a user may manipulate the selector mechanism 18 to move the blocking mechanism 40 from a one pill or two pill position. A first series of magnets 38 may be located on a bottom portion of the diaphragm 48, and a second series of magnets 22 located on a top portion of the bottom container 20. The bottom container 20 is attached to the diaphragm 48 by connecting the first series of magnets 38 to the second series of magnets 22, but may include, and is not limited to, singular magnets, a friction fit, or any other fit that could be reasonably inferred by a person of ordinary skill in the art. The selector mechanism 18 may comprise a locking mechanism 50 that includes a lobe 80 located on a distal end of the selector mechanism 18, which is configured to engage with a first recess 82 or a second recess 84, located on an interior side portion of the pill dispenser 10. Upon rotation, the selector mechanism 18 may be indexed in 180-degree increments and the locking mechanism 50 locks the selector mechanism 18 into place when the lobe 80 engages with the first recess 82 or second recess 84, to prevent involuntary motion. As best shown in FIGS. 9 and 10, the pill dispenser 10 comprises a first sleeve 36 in the first assembly 24, that encompasses the push rod 30 through the storage container 12. The first sleeve 36 includes a first sleeve cutout 76 that is designed to receive a second sleeve complementary cutout 78. The second sleeve 36 in the second assembly 26 encompasses the push rod 30 through the diaphragm 40, including a second sleeve complementary cutout 78 which is designed to fit into the first sleeve cutout 76. When the top pusher cap 11 is displaced, the first sleeve 34 is displaced along with the push rod 30, causing the second sleeve 36 to rotate with the first sleeve 34. The first sleeve cutout 76 and second sleeve complementary cutout 78 are used so that, when rotation occurs, the second sleeve 36 and first sleeve 34 are not detached from one another, allowing for coherent movement within the pill dispenser 10.

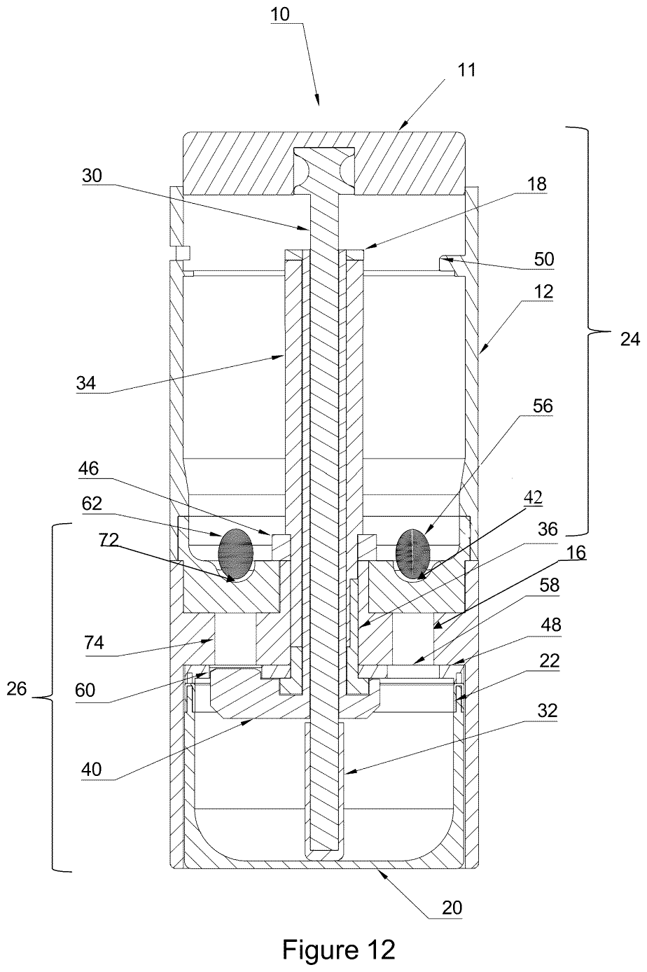

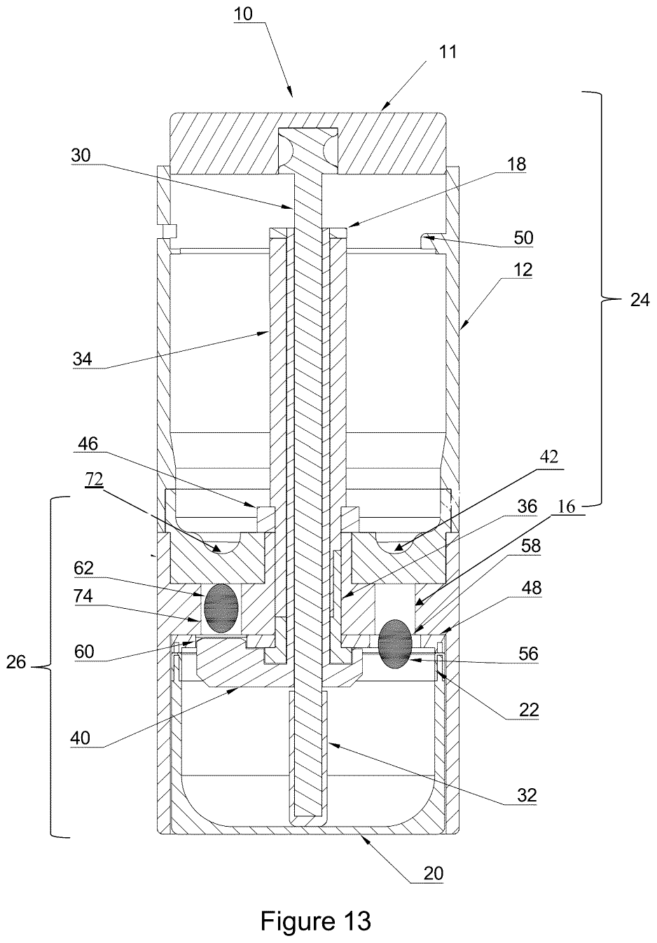

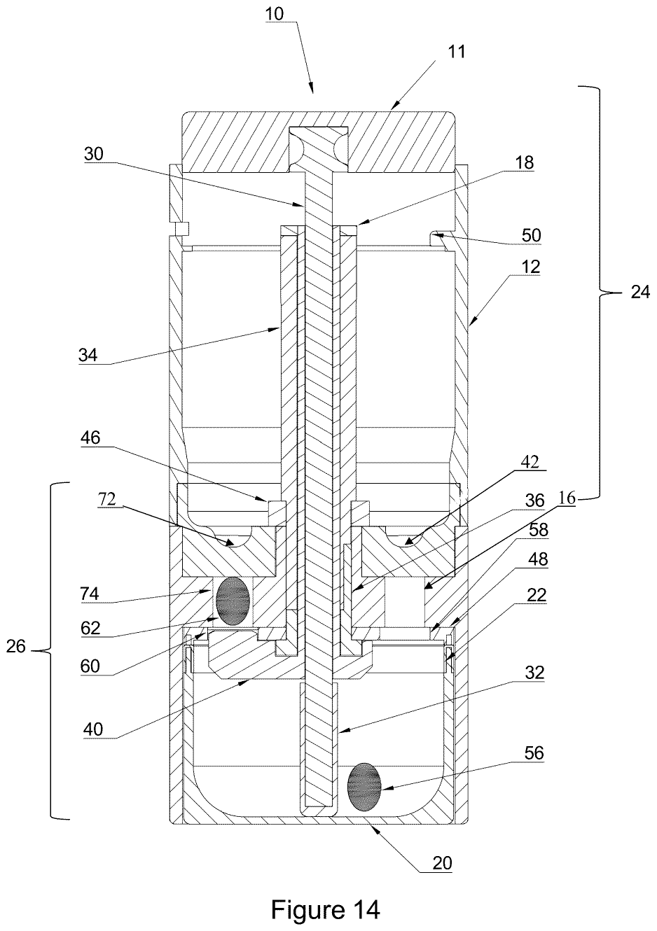

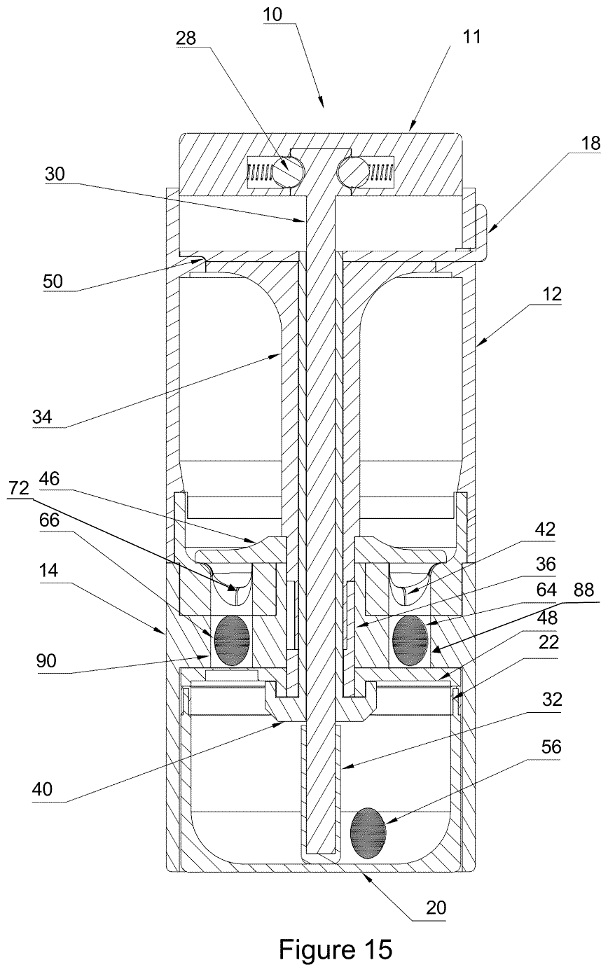

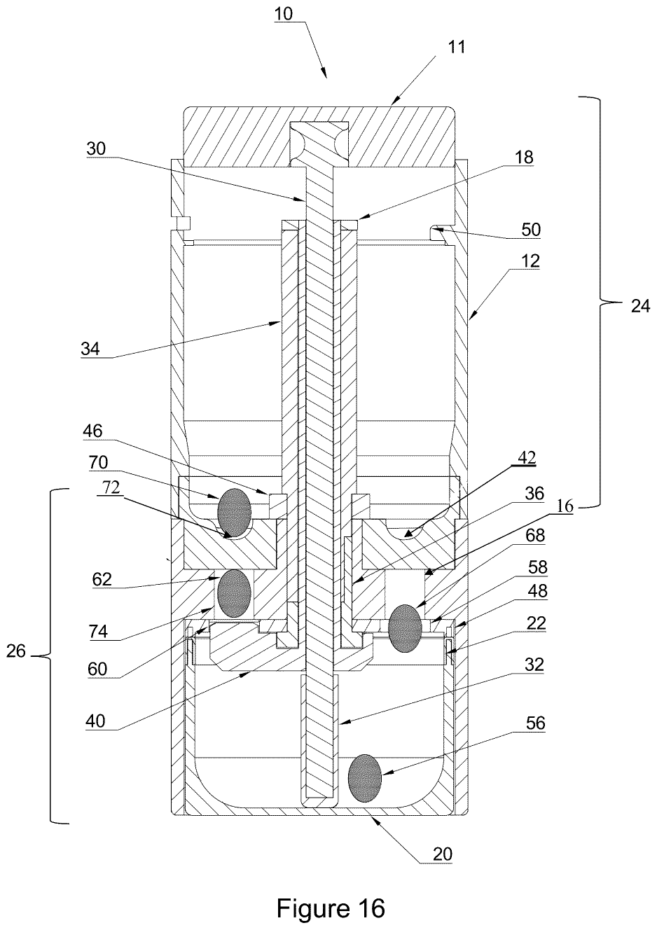

As best understood by comparing FIGS. 12-16, a plurality of pills (not shown) may be placed into the pill dispenser 10 by removing the top pusher cap 11 and inserting the plurality of pills into the pill dispenser 10. When the plurality of pills are inserted into the pill dispenser 10, they are held in the storage container 12 until a user manipulates the first assembly 24 and second assembly 26. When a user manipulates the first assembly 24 and second assembly 26 by rotating each opposite each other on a central axis, the agitator 46 agitates the plurality of pills, causing a first pill 56 to be diverted into the first funnel 42 and falls into and occupies the first staging area 16, and causing a second pill 62 to be diverted into the second funnel 72 and falls into and occupies the second staging area 74. For purposes of discussion, only the first staging area 16 and second staging area 74 are shown and described for FIGS. 12-15. FIG. 16 depicts the third staging area 88 and fourth staging area 90, but does not show the first staging area 16 or the second staging area 74. FIG. 16 best represents cross-section 2:2, as depicted in FIG. 2. It should be understood that there are at least four staging areas, as depicted in FIGS. 7 and 8. Upon further rotation of the first assembly 24 and second assembly 26 opposite each other on a central axis, pills will fall into and occupy the staging area that does not have a pill. When the first pill 56 and second pill 62 are positioned above the first opening 58 and second opening 74, respectively, a user may again manipulate the first assembly 24 and second assembly 26 by rotating each opposite each other on a central axis. When the rotation occurs, the first staging area 16 and second staging area 74 align with the first opening 58 and second opening 60 of the diaphragm 48. In the one pill position, as shown in FIGS. 12-15, the blocking mechanism 40 is in the one pill position, resulting in the first pill 56 being dispensed from the first staging area 16 through the first opening 58, into the bottom container 20. The second pill 62 remains in the second staging area 74 until the blocking mechanism 40 is manipulated to the two pill position. In that same rotation, as best shown in FIG. 16, a third pill 64 will be fall into and occupy the third staging area 88 and a fourth pill 66 will fall into and occupy the fourth staging area 90. With the blocking mechanism 40 in the two pill position, a user may continue to rotate the first assembly 24 and the second assembly 26. A fifth pill 68 will fall through the first staging area 16, into the bottom container 20. A sixth pill 70 will be diverted into the second funnel 72, but because there already is a pill in the second staging area 74 blocked from being dispensed into the bottom container 20, the sixth pill 70 will remain in the second funnel 72 until the blocking mechanism 40 is manipulated. Upon further rotation of the first assembly 24 and the second assembly 26, the first opening 58 will align with the first staging area 16, allowing the third pill 64 to be dispensed from the first staging area 16 through the diaphragm 48, into the bottom container 20. A user may then depress the top pusher cap 11 on a top portion of the pill dispenser 10 such that a ball detent 28 engages with the top pusher cap 11 to lock the top pusher cap 11 into place and prevent involuntary motion. A push rod 30 transfers motion from the top pusher cap 11 to a push rod cap 32. The push rod 30 is housed in a first sleeve 34 and second sleeve 36, comprising a center pin (not shown). The motion from the top pusher cap 11 and the push rod 30 is transferred to the push rod cap 32 so that the bottom container 20 with the second series of magnets 22 that is connected to a first series of magnets 38 disengages from a blocking mechanism 40. When the bottom container 20 disengages from the diaphragm 48, a user may then consume the first pill 56 and third pill 64.

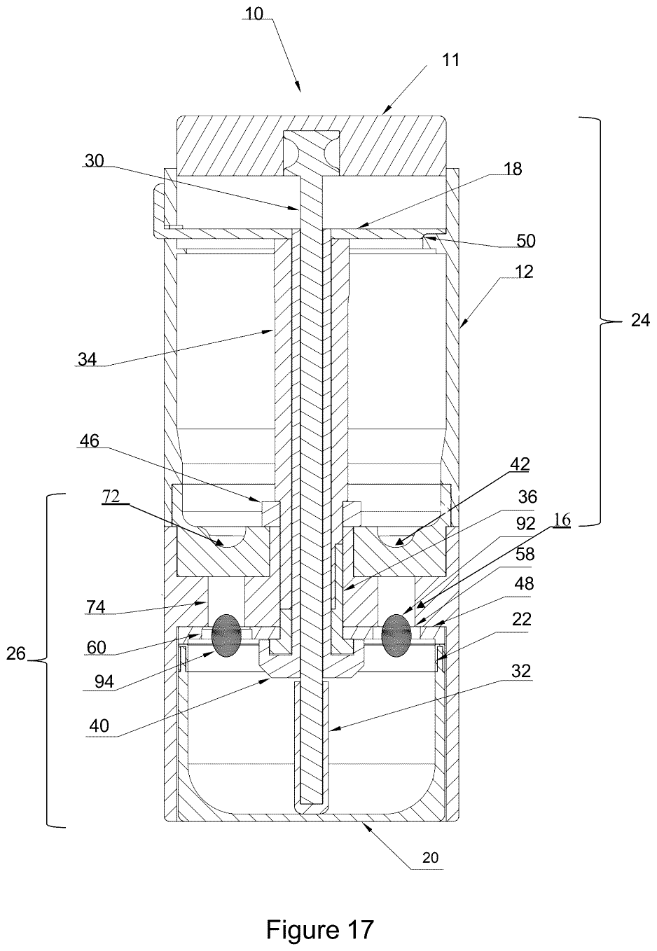

As best understood by FIG. 17, in view of FIGS. 12-16, a plurality of pills (not shown) may be placed into the pill dispenser 10 by removing the top pusher cap 11 and inserting the plurality of pills into the pill dispenser 10. When the plurality of pills are inserted into the pill dispenser 10, they are held in the storage container 12 until a user manipulates the first assembly 24 and second assembly 26. When a user manipulates the first assembly 24 and second assembly 26 by rotating each opposite each other on a central axis, the agitator 46 agitates the plurality of pills, causing a seventh pill 92 to be diverted into the first funnel 42 and falls into and occupies the first staging area 16, and causing an eighth pill 94 to be diverted into the second funnel 72 and falls into and occupies the second staging area 74. For purposes of discussion, only the first staging area 16 and second staging area 74 are shown and described for FIG. 16. It should be understood that there are at least four staging areas, as depicted in FIGS. 7 and 8. Upon further rotation of the first assembly 24 and second assembly 26 opposite each other on a central axis, pills will fall into and occupy the staging area that does not have a pill. When the seventh pill 92 and eighth pill 94 are positioned above the first opening 58 and second opening 74, respectively, a user may again manipulate the first assembly 24 and second assembly 26 by rotating each opposite each other on a central axis. When the rotation occurs, the first staging area 16 and second staging area 74 align with the first opening 58 and second opening 60 of the diaphragm 48. In the two pill position, as shown in FIG. 16, the blocking mechanism 40 is in the two pill position, resulting in the seventh pill 92 and eighth pill 94 being dispensed from the first staging area 16 through the first opening 58, into the bottom container 20. A user may then depress the top pusher cap 11 on a top portion of the pill dispenser 10 such that a ball detent 28 engages with the top pusher cap 11 to lock the top pusher cap 11 into place and prevent involuntary motion. A push rod 30 transfers motion from the top pusher cap 11 to a push rod cap 32. The push rod 30 is housed in a first sleeve 34 and second sleeve 36, comprising a center pin (not shown). The motion from the top pusher cap 11 and the push rod 30 is transferred to the push rod cap 32 so that the bottom container 20 with the second series of magnets 22 that is connected to a first series of magnets 38 disengages from a blocking mechanism 40. When the bottom container 20 disengages from the diaphragm 48, a user may then consume the seventh pill 92 and eighth pill 94.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A pill dispenser comprising:
a first assembly comprising:
a storage container for holding a plurality of pills; and
a first funnel attached to a bottom portion of said storage container for directing said plurality of pills to a first staging area;
a second assembly comprising:
a diaphragm comprising a first opening configured to fit one of said plurality of pills; and
an agitator positioned within said storage container of said first assembly;
wherein said first assembly and second assembly may be rotated opposite to each other along a central axis such that said agitator agitates said plurality of pills, causing a first pill to be diverted into said first funnel and falls into and occupies said first staging area, and said first opening aligns with said first staging area allowing said first pill to be dispensed from said first staging area through said diaphragm.

2. The pill dispenser of claim 1, further comprising:
said first assembly further comprising a second staging area configured to fit one of said plurality of pills;
said first assembly further comprising a second funnel attached to a bottom portion of said storage container for directing said plurality of pills to said second staging area;
said diaphragm further comprising a second opening configured to fit one of said plurality of pills;
wherein rotation of said first assembly and said second assembly opposite to each other along said central axis causes said agitator to agitates said plurality of pills, causing a second pill to be diverted into said second funnel and falls into and occupies said second staging area, and said second opening aligns with said second staging area allowing said second pill to be dispensed from said second staging area through said diaphragm.

3. The pill dispenser of claim 2 further comprising a blocking mechanism that can be manipulated to block one of said first opening or said second opening such that only said first pill or said second pill is dispensed from said first assembly through said second assembly.

4. The pill dispenser of claim 2 further comprising a blocking mechanism that can be manipulated to block one of said first funnel or said second funnel such that only said first pill or said second pill is dispensed from said first assembly through said second assembly.

5. The pill dispenser of claim 1 further comprising a collection cap positioned below said diaphragm for collecting said pills after being dispensed through said diaphragm.

6. The pill dispenser of claim 1 further comprising:
a collection cap positioned below said diaphragm for collecting said pills after being dispensed through said diaphragm; and
a series of magnets attached to said collection cap and/or said diaphragm for securing said collection cap to said diaphragm.

7. The pill dispenser of claim 6 further comprising:
a top pusher cap positioned above said storage container;
a push rod connected to said top pusher cap and positioned through a center of said pill dispenser; and
wherein when displacing said top pusher cap in a vertical direction, said push rod is simultaneously displaced vertically to engage said collection cap and disengage said series of magnets such that said collection cap is detached from the pill dispenser and one of said plurality of pills can be retrieved from said collection cap.

8. The pill dispenser of claim 7 further comprising:
a detent in said top pusher cap including a ball bearing and spring; and
said detent configured to lock said push rod in place when said top pusher cap is displaced.

9. The pill dispenser of claim 7 further comprising a cover positioned between said top pusher cap and said storage container to prevent said pills from interfering with said top pusher cap.

10. The pill dispenser of claim 7 further comprising:
a first sleeve in said first assembly that encompasses said pushrod through said storage container;
said first sleeve includes a cutout designed to receive a complementary cutout;
a second sleeve in said second assembly that encompasses said pushrod through said diaphragm;
said second sleeve includes a complementary cutout designed to fit into said cutout from said first sleeve; and
wherein when displacing said top pusher cap, said first sleeve is displaced along with said push rod causing second sleeve to rotate with said first sleeve.

11. The pill dispenser of claim 1 further comprising a spring loaded ball bearing and a series of recesses such that, when said first assembly is rotated relative to said second assembly, said spring loaded ball bearing engages one of said series of recesses when said first staging area aligns with said first opening.

12. The pill dispenser of claim 1 further comprising a spring loaded ball bearing and a series of recesses such that, when said first assembly is rotated relative to said second assembly, said spring loaded ball bearing engages one of said series of recesses when said second staging area aligns with said second opening.

13. The pill dispenser of claim 3 further comprising a selector mechanism attached to said blocking mechanism and extending to an external side portion of the pill dispenser for manipulation of said blocking mechanism.

14. The pill dispenser of claim 12 further comprising:
a locking mechanism that comprises:
a lobe located on a distal end of said selector mechanism;
two recesses located on opposite sides of an interior side portion of the pill dispenser; and
said lobe is engageable with one of said recesses;
wherein rotation of said selector mechanism rotates said locking mechanism such that said selector mechanism is indexed in 180 degree increments and is locked into place when said lobe engages one of said recesses to prevent rotation of said selector mechanism.

15. A pill dispenser comprising:
a first assembly comprising:
a storage container for holding a plurality of pills; and
a first funnel attached to a bottom portion of said storage container for directing said plurality of pills to a first staging area;
a second assembly comprising:
a diaphragm comprising:
a first opening configured to fit one of said plurality of pills; and
a first series of magnets; and
an agitator positioned within said storage container of said first assembly;
a collection cap having a second series of magnets for magnetic attachment to said first series of magnets;
a top pusher cap positioned above said storage container; and
a push rod connected to said top pusher cap and positioned through a center of said pill dispenser;
wherein said first assembly and second assembly may be rotated opposite each other along a central axis such that said agitator agitates said plurality of pills, causing a first pill to be diverted to fall into and occupy said first staging area and further rotation of said first assembly and second assembly aligns said first opening with said first staging area thereby allowing said first pill to be dispensed through said first opening into said collection cap; and
wherein when displacing said top pusher cap in a vertical direction, said push rod is simultaneously displaced vertically to engage said collection cap and disengage said first series of magnets from said second series of magnets such that said collection cap is detached from the pill dispenser and said pill can be retrieved from said collection cap.

16. A pill dispenser comprising:
a first assembly comprising:
a storage container for holding a plurality of pills; and
a first funnel attached to a bottom portion of said storage container for directing said plurality of pills to a first staging area;
a second funnel attached to a bottom portion of said storage container for directing said plurality of pills to a second staging area;
a second assembly comprising:
a diaphragm comprising:
a first opening and a second opening each configured to fit one of said plurality of pills; and
a first series of magnets;
an agitator positioned within said storage container of said first assembly; and
a collection cap having a second series of magnets for magnetic attachment to said first series of magnets;
a top pusher cap positioned above said storage container; and
a push rod connected to said top pusher cap and positioned through a center of said pill dispenser;
wherein said first assembly and second assembly may be rotated opposite each other along a central axis such that said agitator agitates said plurality of pills, causing a first pill of said plurality of pills to be diverted to fall into and occupy said first staging area and a second pill of said plurality of pills to be diverted to fall into and occupy said second staging area and further rotation of said first assembly and second assembly aligns said first opening with said first staging area and aligns said second opening with said second staging area, thereby allowing said first pill and said second pill to be dispensed through said first opening and said second opening, respectively, and into said collection cap; and
wherein when displacing said top pusher cap in a vertical direction, said push rod is simultaneously displaced vertically to engage said collection cap and disengage said first series of magnets from said second series of magnets such that said collection cap is detached from the pill dispenser and said pill can be retrieved from said collection cap.
